(19) United States
(12) Patent Application Publication
(10) Pub. No.: US 2012/0293824 A1
(43) Pub. Date: Nov. 22, 2012

(54) IMAGE FORMING APPARATUS AND SHEET JAM TREATMENT METHOD FOR THE IMAGE FORMING APPARATUS

(75) Inventor: Masato Ogasawara, Tokyo (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/428,191

(22) Filed: Mar. 23, 2012

Related U.S. Application Data
(60) Provisional application No. 61/467,647, filed on Mar. 25, 2011.

(30) Foreign Application Priority Data
Mar. 6, 2012 (JP) 2012-48918

(51) Int. Cl. G06K 15/16; B65H 7/12

(52) U.S. Cl. 358/1.14; 271/262

(57) ABSTRACT

The image forming apparatus according to the embodiment includes a display section configured to display information or an inquiry, an input section configured to receive an input from the operator; and a control section configured to display, when the sheet jam occurs, an inquiry concerning a situation of the occurrence of the sheet jam on the display section and a method to eliminate a cause of the sheet jam estimated on the basis of input in response to the displayed inquiry.

### CROSS-REFERENCE TO RELATED APPLICATIONS

This application is based upon and claims the benefit of priority from Provisional U.S. Application No. 61/467,647, filed on Mar. 25, 2011, the entire contents of which are incorporated herein by reference.

This application is also based upon and claims the benefit of priority from the prior Japanese Patent Applications No. 2012-48918, filed on Mar. 6, 2012, the entire contents of which are incorporated herein by reference.

### FIELD

Embodiments described herein relate generally to an image forming apparatus and a treatment method for sheet jam removal in the image forming apparatus.

### BACKGROUND

In general, an image forming apparatus such as a copying machine adopts a process for feeding and conveying a sheet to an image forming section, forming an image on the sheet, and then discharging the sheet to the outside of the apparatus. A sheet jam, i.e., a so-called jam in a conveying path sometimes occurs from the sheet feeding until the sheet is finally discharged. As a cause of the jam, various causes are conceivable. The jam could occur because, for example, a large number of sheets are fed, the sheet fails to be fed, the sheet is caught in the conveying path, a wrong size of the sheet is set, a nonstandard sheet is used, or a conveying roller is deteriorated.

If a jam occurs not accidentally, it is necessary to specify a cause of the occurrence of the jam and quickly perform treatment. However, as explained above, since there are various causes of the jam, it is often not easy to grasp a cause of the jam. Therefore, even if a user performs work for removing the jammed sheet, it is difficult for the user to appropriately perform essential work corresponding to a cause of the jam. Further, even if the user takes some measures at his or her decision, the measures tend to be insufficient. Therefore, even if the apparatus is restored, a jam occurs again and supply of sheets, toners, and the like and labor of the user are uselessly consumed.

Therefore, the user calls a serviceperson and the serviceperson diagnoses the jam in the image forming apparatus, estimates a cause of the jam, and repairs the image forming apparatus. However, if such a method is used to cope with the jam, the image forming apparatus cannot be used until the serviceperson completes the repair. This is extremely inconvenient for the user.

### DESCRIPTION OF THE DRAWINGS

FIG. 1 is a schematic structural view showing an image forming apparatus in an embodiment;

FIG. 2 is a partially enlarged sectional view of the image forming apparatus;

FIG. 3 is a diagram showing an operation panel of the image forming apparatus;

FIG. 4 is a block diagram showing the configuration of the image forming apparatus;

FIG. 5 is a flowchart for explaining a processing operation performed during jam treatment in the image forming apparatus;

FIG. 6 is a diagram of an example of a jam occurrence place displayed on the operation panel during jam occurrence in the image forming apparatus; and

FIG. 7 is a diagram of an example of an inquiry message displayed on the operation panel for inquiring about a jam occurrence situation of the image forming apparatus.

### DETAILED DESCRIPTION

Exemplary embodiments are explained below.

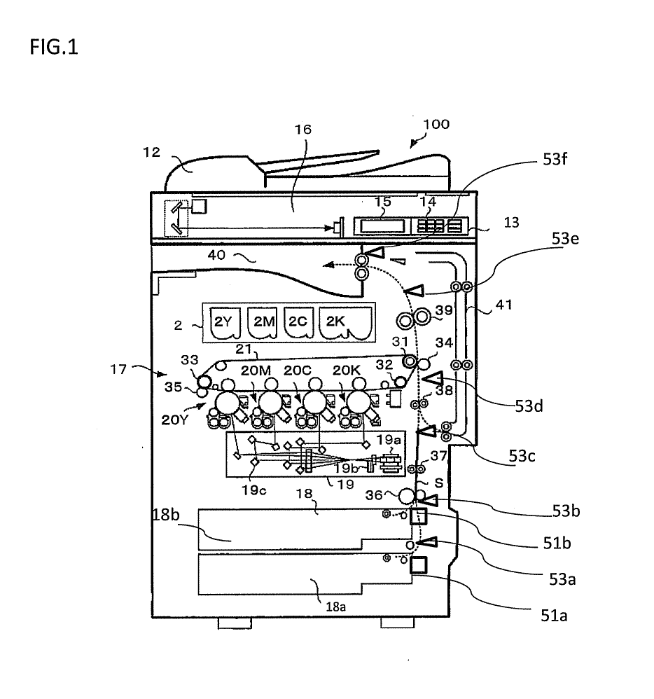

FIG. 1 is a configuration diagram showing an image forming apparatus according to an embodiment. The image forming apparatus is, for example, an MFP (Multi-Function Peripheral), which is a compound machine, a printer, or a copying machine. In the embodiment shown in FIG. 1, a color MFP is explained as an example. In the following explanation, a sheet jam of a sheet is described as jam as appropriate.

An MFP 100 includes an auto document feeder (ADF) 12, an operation panel 13, a scanner section 16, a printer section 17, and paper feeding cassettes (paper feeding sections) 18a and 18b. The paper feeding cassettes 18a and 18b are collectively referred to as paper feeding cassette 18.

The MFP 100 includes a separation roller 36 that picks up a sheet S in the paper feeding cassette 18, a conveying roller 37, and a registration roller 38 between the paper feeding cassette 18 and a paper discharge section 40. Further, the MFP 100 includes a fixing device 39 in a position further downstream in the direction of sheet conveyance by the registration roller 38 than a secondary transfer position of an intermediate transfer belt 21 explained below. The MFP 100 includes the paper discharge section 40 and a reversal conveying path 41 downstream of the fixing device 39. The sheet S having a toner image fixed thereon by the fixing device 39 is discharged to the paper discharge section 40. The reversal conveying path 41 reverses the sheet S and leads the sheet S in the direction of a secondary transfer roller 34. The reversal conveying path 41 is used when duplex printing is performed.

Usually, the sheets S of different sizes such as A3 and A4 are respectively stored in the paper feeding cassettes 18a and 18b. Sheet size sensors 51a and 51b (collectively referred to as sheet size sensor 51) for detecting the sizes of the stored sheets S are respectively provided in the paper feeding cassettes 18a and 18b.

Conveyance sensors 53a to 53f (collectively referred to as conveyance sensor 53) that detect conveyance timing are arranged in a conveying path for feeding of the sheets S from the paper feeding cassettes 18a and 18b, transfer of an image, fixing of the image, and discharge of the sheets S. As the conveyance sensors 53a to 53f, for example, a photo-interrupter in which a light-emitting device and a light-receiving device, which are publicly known devices, form a pair is used.

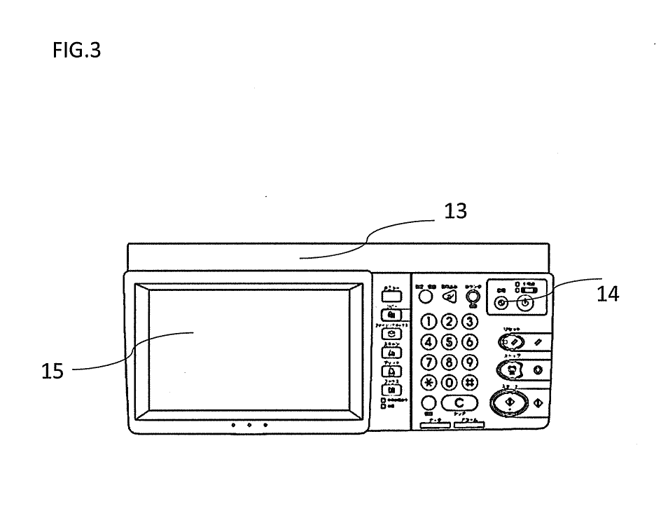

The ADF 12 shown in FIG. 1 is openably and closably provided on a document table and automatically conveys an original document. The operation panel 13 includes an operation key 14 including various keys and a display section 15 of a touch panel type. The operation panel 13 is shown in FIG. 3. In FIG. 3, the operation key 14 includes a ten key, a clear and stop key, a start key, a screen switching key, and an operation-display control section. The display section 15 includes an operation panel of a touch panel type. An operator recognizes predetermined input setting, a state of the apparatus, and the like according to display of the operation panel. The operator performs necessary input from the operation panel. The operation panel 13 includes, as functions, an input section that receive inputs from the outside and a display section. However, as explained above, the display section 15 may be the touch panel type and receive a part of the inputs from the outside. In this case, the input section includes a part of the display section.

The scanner section 16 is provided under the ADF 12. The scanner section 16 reads an original document fed by the ADF 12 or an original document placed on the document table and generates image data.

The printer section 17 is an image forming section and includes a laser exposing device 19. The printer section 17 processes image data read by the scanner section 16 or image data created by a PC or the like connected as an external terminal via a communication interface (not shown) and forms an image on the sheet S.

The laser exposing device 19 includes a polygon mirror 19a, a focusing lens system 19b, and a mirror 19c. The laser exposing device 19 scans a laser beam, which is emitted from a semiconductor laser device and modulated according to the image data, in the axis direction of a rotating photoconductive drum 22 of an image forming station explained below using the polygon mirror 19a.

The printer section 17 includes image forming stations 20Y, 20M, 20C, and 20K for colors yellow (Y), magenta (M), cyan (C), and black (K). The image forming stations 20Y, 20M, 20C, and 20K are arranged on the lower side of the intermediate transfer belt 21 from an upstream side to a downstream side in a moving direction of the intermediate transfer belt 21.

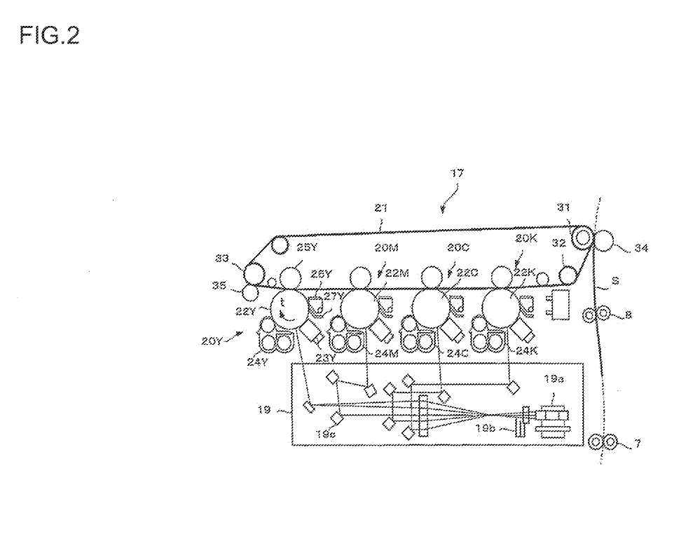

FIG. 2 is an enlarged diagram of the printer section 17 including the image forming stations 20Y, 20M, 20C, and 20K. In the following explanation, since the image forming stations 20Y, 20M, 20C, and 20K have the same configuration, the image forming station 20Y is representatively explained.

The image forming station 20Y includes a photoconductive drum 22Y functioning as an image bearing member. An electrifying charger 23Y, a developing device 24Y arranged to be opposed to the electrifying charger 23Y across an exposing position of the photoconductive drum 22Y, a primary transfer roller 25Y, and a cleaner 26Y are arranged around the photoconductive drum 22Y along a rotating direction t. The primary transfer roller 25Y is in contact with the photoconductive drum 22Y via the intermediate transfer belt 21. The cleaner 26Y includes a blade 27Y.

The electrifying charger 23Y of the image forming station 20Y uniformly charges the entire surface of the photoconductive drum 22Y. The laser exposing device 19 irradiates the laser beam, which is modulated according to image data corresponding to yellow, on the exposing position on the surface of the charged photoconductive drum 22Y to form an electrostatic latent image. The developing device 24Y supplies, using a developing roller to which a developing bias is applied, a two-component developer including a yellow toner and a carrier to the photoconductive drum 22Y. The electrostatic latent image on the photoconductive drum 22Y is developed with the supplied developer (into a toner image). After a transfer process explained below, the cleaner 26Y removes, using the blade 27Y, a residual toner on the surface of the photoconductive drum 22Y not transferred in the transfer process.

As shown in FIG. 1, a toner cartridge 2 (a developer storing section) for supplying toners to developing devices 24Y, 24M, 24C, and 24K is provided above the image forming stations 20Y, 20M, 20C, and 20K. In the toner cartridge 2, toner cartridges 2Y, 2M, 2C, and 2K for the colors yellow (Y), magenta (M), cyan (C), and black (K) are adjacent to one another. Among the toner cartridges for the colors, only the toner cartridge 2K for black (K) has a large capacity. This is because a consumed amount of the black toner is the largest in normal image formation.

In FIG. 1, the endless intermediate transfer belt 21 cyclically moves. For example, semi-conductive polyimide is used in terms of heat resistance and abrasion resistance. The intermediate transfer belt 21 is stretched and suspended around a driving roller 31 and driven rollers 32 and 33 and opposed to and in contact with photoconductive drums 22Y, 22M, 22C, and 22K. A primary transfer voltage is applied by the primary transfer roller 25Y to a position of the intermediate transfer belt 21 opposed to the photoconductive drum 22Y (a primary transfer position) to primarily transfer the toner image on the photoconductive drum 22Y onto the intermediate transfer belt 21. Therefore, according to the movement of the intermediate transfer belt 21, toner images of the colors formed by the image forming stations 20Y, 20M, 20C, and 20K are sequentially transferred onto the intermediate transfer belt 21 and superimposed one on top of another to form a color toner image on the intermediate transfer belt 21.

The secondary transfer roller 34 is arranged to be opposed to a secondary transfer position of the driving roller 31 around which the intermediate transfer belt 21 is stretched and suspended. On the other hand, the sheet S picked up from the paper feeding cassette 18 by the separation roller 36 is conveyed to (the secondary transfer position) between the intermediate transfer belt 21 and the secondary transfer roller 34 via the conveying roller 37 and the registration roller 38. When the sheet S passes the secondary transfer position, the secondary transfer roller 34 applies a secondary transfer voltage to the sheet S to secondarily transfer the color toner image on the intermediate transfer belt 21 onto the sheet S. The sheet S having the toner image transferred thereon is discharged to the paper discharge section 40 after the toner image is fixed thereon by the fixing device 39. A belt cleaner 35 is arranged near the driven roller 33 of the intermediate transfer belt 21. The belt cleaner 35 cleans a residual toner not transferred onto the sheet S in the secondary transfer process.

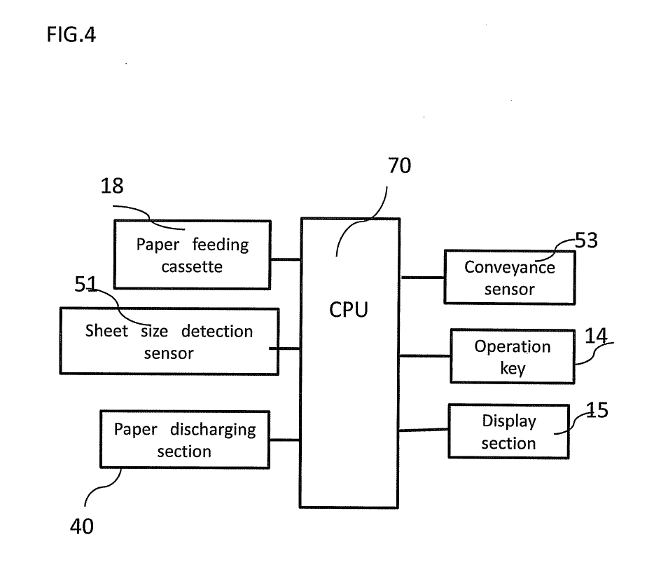

FIG. 4 is a block diagram of the configuration of the color MFP 100 shown in FIG. 1.

A CPU 70 is a control section that controls the entire MFP 100. The CPU 70 performs, via the operation key 14 and the display section 15, control of display to the operator, control of function setting input from the operator, control of input from the scanner section 16, a document image data storage control, and control of image formation in the printer section 17. The CPU 70 determines a state of the apparatus on the basis of signals detected by the sheet size sensor 51 and the conveyance sensor 53 and performs exchange of operation commands.

The CPU 70 functions as jam detecting means as well. The CPU 70 detects occurrence of a sheet jam (a jam) using the conveyance sensors 53a to 53f arranged in the paper feeding and conveying path. Further, the CPU 70 also has a function of displaying a message for inquiring the operator about a situation of the jam on the display section 15 and estimating a cause of the jam on the basis of contents input by the operator in response to the inquiry.

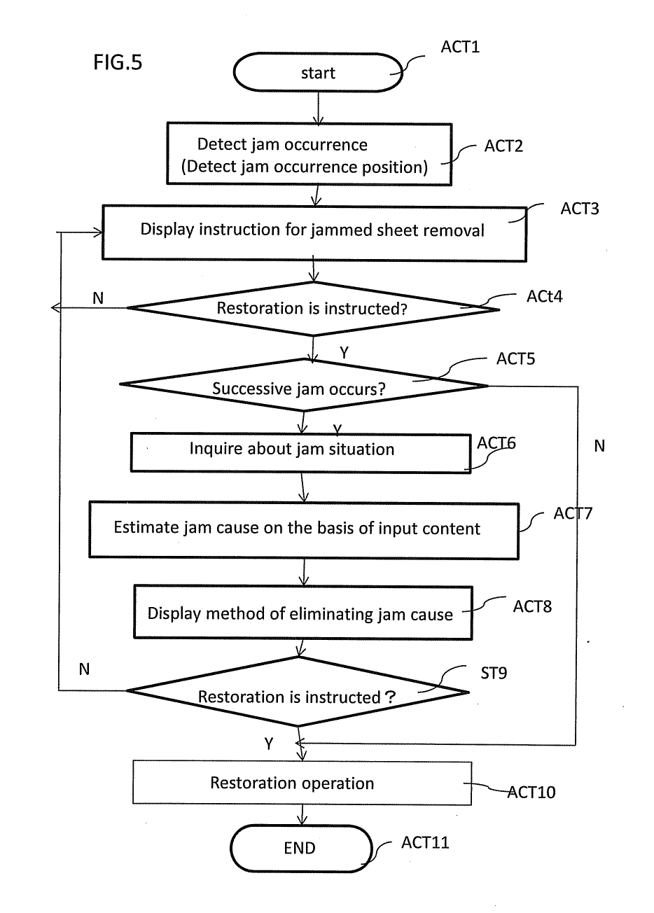

An operation performed when a jam occurs in the sheet conveying path in the MFP 100 is explained. If a jam occurs not accidentally, unless a cause of the occurrence is eliminated, a jam recurs because of the same cause. In order to prevent such recurrence, the MFP 100 executes an operation shown in FIG. 5 during the jam occurrence.

FIG. 5 is a flowchart for explaining the processing operation during the jam occurrence. In FIG. 5, first, the CPU 70 detects occurrence of a sheet jam on the basis of detection signals of the conveyance sensors 53a to 53f. At the same time, the CPU 70 detects an occurrence position of the jam from the detection signals of the conveyance sensors 53a to 53f (ACT 2). The CPU 70 performs, on the display section 15, display for notifying the operator of the occurrence of the jam and the occurrence position of the jam to urge the operator to remove the jam (ACT 3)

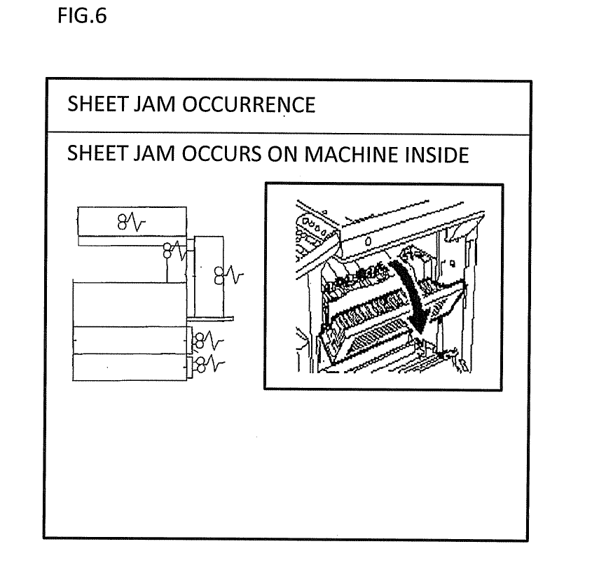

A display example of a jam occurrence place displayed on the display section 15 during jam occurrence is shown in FIG. 6. In FIG. 6, display performed when jams occur in all detection positions is shown. However, usually, a jam mark is displayed in one or two or more places where jam occurrence is detected.

Referring back to FIG. 5, the operator inspects the displayed jam occurrence position and performs treatment for, for example, removing a sheet. After the treatment, when CPU70 judges there are no sheets in the MFP100, CPU starts restoring the MFP100 from a jam occurrence state. After restoration operation, the suspended copying job can be restarted automatically. Otherwise, a message to ask if the user would like to restart the suspended copying job, or cancel the job can be displayed on the display section 15. This configuration is set by an administrator or a serviceperson of the MFP100.

FIG. 5 shows a flow that the operator inputs the instruction to start the restoration operation using the operation key 14 or the touch panel of the display section 15. (Y in ACT4)

In the MFP 100, the CPU 70 determines whether the restoration operation instruction is received (ACT 4). If the restoration operation instruction is received (Y in ACT 4), the CPU 70 determines whether the jam successively occurs in the same place (ACT 5). If the CPU 70 determines that the jam occurs for the first time (N in ACT 5), the CPU 70 immediately performs the restoration operation. After the restoration operation, the CPU 70 resumes a suspended copying job.

If a cause of the occurrence of the jam is not eliminated simply by removing the sheet, in most cases, a jam recurs after the job is resumed. If the CPU 70 determines that the jam successively occurs in the same place (Y in ACT 5), the CPU 70 prohibits starting the restoration operation automatically. The CPU 70 enters a flow for investigating a cause of the jam.

If the CPU 70 determines in ACT 5 that, for example, the jam successively occurs in the fixing device 39 (Y in ACT 5), it is still highly likely that a cause of the occurrence of the jam still remains in the fixing device 39. Therefore, the CPU 70 inquires on the display section 15 about a situation of the occurrence of the jam in the fixing device 39 (ACT 6).

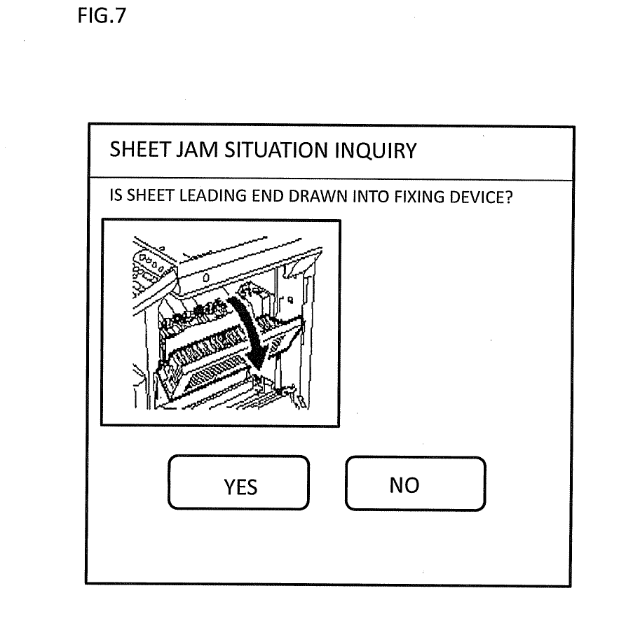

As shown in FIG. 7, for example, the CPU 70 displays an inquiry message “Is the sheet leading end drawn into the fixing device?”. At this point, if the CPU 70 also displays a state of the sheet leading end drawn into the fixing device 39, it is possible to more clearly inform the operator of the contents of the inquiry. At the same time, the CPU 70 causes the display section 15 to display YES and NO on the touch panel.

If YES is input, as the next inquiry, the CPU 70 displays “Is a dense image present at the sheet leading end?” (ACT 5). The CPU 70 displays YES and NO on the touch panel again.

The operator checks an original document that the operator is about to copy. The operator inputs YES or NO to the MFP 100. If the operator inputs YES, the CPU 70 determines that the jam occurs because a dense image is present at the leading end of the original document to be copied (ACT 7). In other words, the CPU 70 selects, on the basis of the input of the operator, an estimated cause of the jam from options determined in advance and displays, as guidance, a method of eliminating the selected cause of the jam (ACT 8). In the example explained above, the CPU 70 performs the guidance display a message to change the up down direction of the original document. The operator vertically reverses the original document according to the guidance display and instructs the restoration operation again (Y in ACT 9). The CPU 70 performs the restoration operation (ACT 10). This display for a dialog between the operator and MFP100 prevents to restore MFP100 automatically until the restoration operation is instructed again.

If NO is input in response to the inquiry display “Is the sheet leading end drawn into the fixing device?”, the CPU 70 determines that a cause of the jam of the fixing device 39 is present in the sheet rather than in the original document. The CPU 70 performs, for example, guidance display “Please turn over and use the sheet for copying” (ACT 8). The operator turns the sheet over and instructs the restoration operation again (ACT 9). After finishing a operator's treatment for the jam, according to the instruction of the operator, the CPU 70 performs the restoration operation (ACT 10) and resumes the suspended job.

In this way, the CPU 70 determines a cause of the jam on the basis of a result of the inquiry about a situation of the occurrence of the jam and displays, as guidance, a method of eliminating the cause to the operator. Consequently, rather than the operator taking measures against a cause of the successive occurrence of the jam on his or her own decision, the MFP 100 displays a method corresponding to a situation and the operator can take measures on the basis of the displayed method. This makes it possible to reduce downtime of the apparatus.

If the cause of the jam is correctly eliminated, the job is finished without causing a jam again. On the other hand, if the cause of the jam is inappropriately determined, it is likely that a jam recurs after the job is resumed. In this case, the CPU 70 determines that it is highly likely that the cause of the jam still remains in the fixing device 39 and, as in the last time, urges the operator to remove the jammed sheet. After the operator removes the jammed sheet, when the CPU 70 receives the restoration operation instruction, the CPU 70 inquires on the display section 15 about a situation of the occurrence of the jam. As in the last time, the inquiry display may include contents for requesting a change of the method of removing the jam, for example, “Please reduce copying density” or “A copy sheet is too thin. Please change the copy sheet to a little thicker one”. Further, an inquiry message different from the last time may be displayed to change the method of coping with the jam.

After narrowing possibilities of the causes for the jam occurrence through the dialog with the operator, when a plurality of resolution methods for the jam are possible to take, a message to tell the operator to instruct to try some method selected from the plurality of methods can be displayed on the display section 15. When the jam continues although the operator take some action following the display, another message to request confirming all the methods shown here are done. When the operator inputs NO for this query that means all methods are not tried yet, a message to lead the operator trying to take other method not yet done can be shown in the display section 15.

If the MFP 100 includes a humidity sensor, for example, the influence of humidity on a sheet can also be taken into account in addition to input contents from the operator. Therefore, it is possible to accurately perform a method of removing the jam by displaying, as guidance, a method of coping with the jam to the operator on the basis of such information concerning the humidity.

If the number of times the jam is successively detected after the resumption of the job is equal to or larger than a fixed number, the MFP 100 determines that repair by a serviceperson is necessary and displays “serviceperson call”.

As explained above, the image forming apparatus according to this embodiment attempts to remove the jam through the inquiry to the operator and the input reply to the inquiry. After the jammed sheet is removed, the operator instructs the restoration operation. The automatic restoration by the apparatus is not performed until the restoration operation is instructed again. Therefore, since the automatic restoration is not performed until the operator finishes work according to the guidance instruction, the operator can safely work. Further, the MFP 100 can surely determine the end of the work.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and their equivalents are intended to cover such forms of modifications as would fall within the scope and spirit of the invention.

What is claimed is:

1. An image forming apparatus comprising:
a sheet feeding section on which a sheet is stacked;
an image forming section configured to form an image on the sheet conveyed from the sheet feeding section;
a paper discharge section to which the sheet having the image formed thereon is further conveyed and discharged;
a detecting member configured to detect a sheet jam that occurs while the sheet is conveyed from the sheet feeding section to the paper discharge section;
a display section configured to display information or an inquiry;
an input section configured to receive an input from the operator; and
a control section configured to display, when the detecting member detects the occurrence of the sheet jam, an inquiry concerning a situation of the occurrence of the sheet jam on the display section and a method to eliminate a cause of the sheet jam estimated on the basis of input in response to the displayed inquiry.

2. The apparatus according to claim 1, wherein the control section prohibits automatic restoration of the apparatus until start of restoration of the apparatus suspended by the sheet jam is instructed.

3. The apparatus according to claim 1, wherein, when a sheet jam successively occurs in a same job, the control section performs the display on the display section.

4. The apparatus according to claim 1, wherein, when a sheet jam successively occurs, the control section displays another inquiry different from a previous inquiry concerning a situation of the occurrence of the sheet jam.

5. The apparatus according to claim 1, wherein, when a sheet jam successively occurs, the control section displays, on the display section another method of removing the sheet jam different from a previous displayed method.

6. The apparatus according to claim 3, wherein, when the sheet jam occurs for a first time in the same job, the control section does not display an inquiry concerning a situation of the occurrence of the sheet jam on the display section.

7. The apparatus according to claim 3, wherein, when a sheet jam successively occurs, the control section displays another inquiry different from a previous inquiry concerning a situation of the occurrence of the sheet jam.

8. The apparatus according to claim 3, wherein, when a sheet jam successively occurs, the control section displays, on the display section another method of removing the sheet jam different from a previous displayed method.

9. A sheet jam treating method comprising:
detecting a sheet jam that occurs when a sheet is conveyed from a sheet feeing section to a paper discharge section through an image forming section;
displaying an inquiry concerning a situation of the occurrence of the sheet jam when the sheet jam is detected;
receiving a reply to the inquiry display; and
displaying a method of eliminating a cause of the sheet jam estimated on the basis of the reply.

10. The method according to claim 9, further comprising prohibiting automatic restoration of an image forming apparatus suspended by the sheet jam until start of restoration of the apparatus is instructed.

11. The method according to claim 9, further comprising performing the display when a sheet jam successively occurs in a same job.

12. The method according to claim 9, further comprising displaying, when a sheet jam successively occurs, another inquiry different from a previous displayed inquiry.

13. The method according to claim 9, further comprising displaying, when a sheet jam successively occurs, on a display section, another method of removing the sheet jam different from a previous displayed method.

14. The method according to claim 11, further comprising not displaying, when the sheet jam occurs for a first time in a same job, an inquiry concerning a state of the occurrence of the sheet jam on a display section.

15. The method according to claim 11, further comprising displaying, when a sheet jam successively occurs, another inquiry different from a previous displayed inquiry.

16. The method according to claim 11, further comprising displaying, when a sheet jam successively occurs, on a display section, another method of removing the sheet jam different from a previous displayed method.
